(19) United States
(12) Patent Application Publication
(10) Pub. No.: US 2013/0326593 A1
(43) Pub. Date: Dec. 5, 2013

(54) WIRELESS DEVICE AND WIRELESS COMMUNICATION METHOD

(71) Applicant: KABUSHIKI KAISHA TOSHIBA, Tokyo (JP)

(72) Inventors: Koji AKITA, Yokohama-shi (JP); Takanobu ISHIBASHI, Yokohama-shi (JP); Takayoshi ITO, Yokohama-shi (JP); Seiichiro HORIKAWA, Yokohama-shi (JP); Ryoko MATSUO, Yokohama-shi (JP)

(21) Appl. No.: 13/908,458

(22) Filed: Jun. 3, 2013

(30) Foreign Application Priority Data
Jun. 4, 2012 (JP) 2012-127393

(51) Int. Cl. H04W 8/24; H04W 12/06

(52) U.S. Cl. CPC H04W 8/24; H04W 12/06
USPC 726/4; 709/217

(57) ABSTRACT

A wireless device has a first information acquisition part to acquire first information when the wireless device passes through a first gate, a second information generator to generate second information necessary to acquire data, by using the first information, and a data acquisition part to acquire the data transmitted from a data providing apparatus through wireless communication, by using the second information.

### CROSS REFERENCE TO RELATED APPLICATIONS

This application is based upon and claims the benefit of priority from the prior Japanese Patent Application No. 2012-127393, filed on Jun. 4, 2012 the entire contents of which are incorporated herein by reference.

### FIELD

Embodiments of the present invention relate to a wireless device and a wireless communication method.

### BACKGROUND

There is known a technique in which a device installed within a specific zone provides a password for accessing an access point of a wireless LAN. This technique can limit the area where the access point is accessible since it is impossible to access the access point without acquiring the password from the device installed within the specific zone.

However, the above technique merely limits the area where the access point is accessible, and does not intend to distinguish respective users and wireless devices to restrict access as needed.

Accordingly, a user terminal located within the area where the access point is accessible can perform wireless communication without restriction.

### BRIEF DESCRIPTION OF THE DRAWINGS

FIG. 1 is a block diagram showing a schematic configuration of a wireless device 1 according to a first embodiment.

FIG. 2 is a diagram showing how a user passes through a first gate 21.

FIG. 3 is a diagram showing how the wireless device acquires data from a data providing apparatus.

FIG. 4 is a diagram showing the position of the first gate 21 and the area where data can be acquired.

FIG. 5 is a diagram showing how the user passes through a second gate 24.

FIG. 6 is a diagram showing the positions of the first and second gates 21 and 24 and the area where data can be acquired.

FIG. 7 is a block diagram showing a schematic configuration of the data providing apparatus 10 according to a fourth embodiment.

FIG. 8 is a sequence diagram showing an example of processing steps when performing authentication using second information.

FIG. 9 is a sequence diagram when transmitting first information from the wireless device 1 to a second information generator 12.

FIG. 10 is a sequence diagram when the second information is an encryption (decryption) key.

FIG. 11 is a block diagram showing a schematic configuration of the wireless device 1 according to a fifth embodiment.

FIG. 12 is a block diagram showing a schematic configuration of the data providing apparatus 10 according to the fifth embodiment.

### DETAILED DESCRIPTION

According to one embodiment, a wireless device has a first information acquisition part to acquire first information when the wireless device passes through a first gate, a second information generator to generate second information, by using the first information, and a data acquisition part configured to acquire data transmitted from another wireless device through wireless communication, by using the second information.

Hereinafter, embodiments of the present invention will be explained referring to the drawings.

### First Embodiment

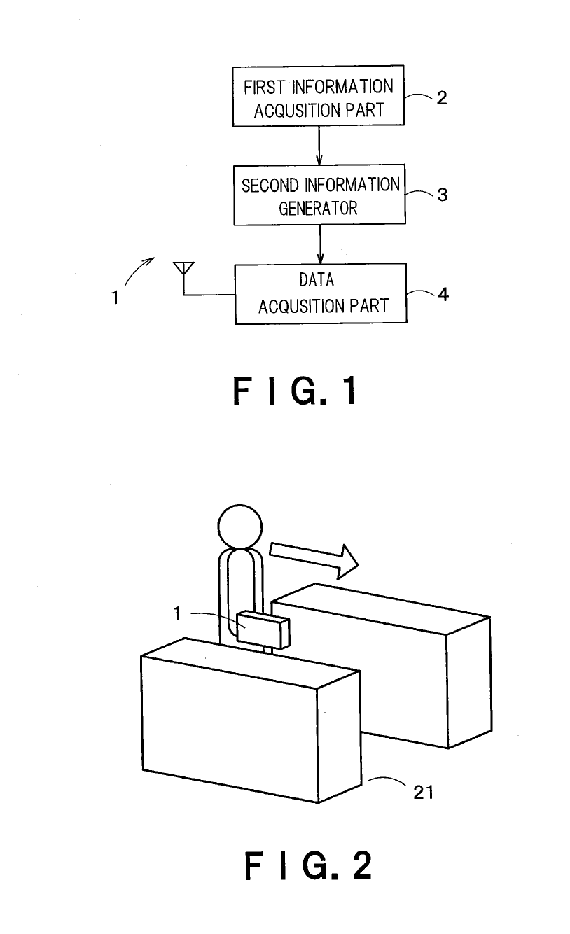

FIG. 1 is a block diagram showing a schematic configuration of a wireless device 1 according to a first embodiment. The wireless device 1 of FIG. 1 is a portable wireless device such as cellular phone, smartphone, personal computer, etc.

The wireless device 1 of FIG. 1 has a first information acquisition part 2, a second information generator 3, and a data acquisition part 4. The first information acquisition part 2 acquires first information when the wireless device 1 passes through a first gate. The second information generator 3 generates second information necessary to acquire data, by using the acquired first information. The data acquisition part 4 acquires the data transmitted from a data providing apparatus (another wireless device) 10 through wireless communication, by using the generated second information.

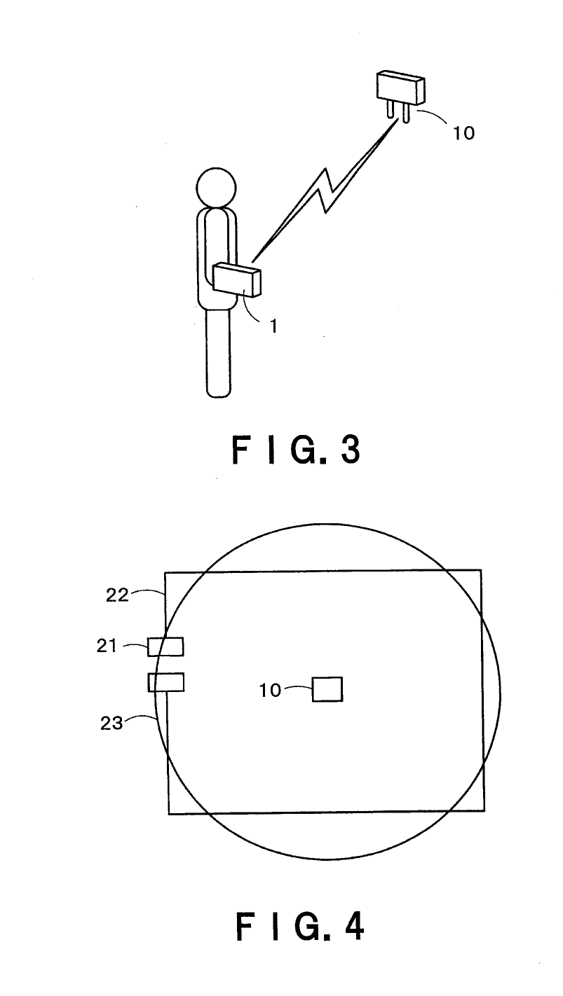

Each of FIGS. 2 and 3 is a diagram showing an arrangement example of the wireless device 1 of FIG. 1, a first gate 21, and the data providing apparatus 10. FIG. 2 shows how a user holding the wireless device 1 of FIG. 1 passes through the first gate 21. FIG. 3 shows how the wireless device 1 acquires data from the data providing apparatus 10 through wireless communication, after the wireless device 1 passes through the first gate 21 and generates the second information by itself.

When the user holding the wireless device 1 passes through the first gate 21 as shown in FIG. 2, the first information acquisition part 2 acquires the first information. The first information is transmitted from the first gate 21, for example. When the user passes through the first gate 21 and enters inside the gate, the data acquisition part 4 acquires data from the data providing apparatus 10 through wireless communication as shown in FIG. 3, by using the second information generated from the first information.

In this way, the wireless device 1 can acquire data only after passing through the first gate 21, and the data cannot be acquired without the second information generated from the first information.

FIG. 4 is a diagram showing the position of the first gate 21 and the area where data can be acquired. As shown in FIG. 4, the first gate 21 is provided at the entrance of a region 22 having a predetermined area. In the example shown in FIG. 4, the region 22 is rectangular, but the shape and size of the region 22 should not be particularly questioned.

The wireless device 1 acquires the first information from the first gate 21, and uses it to generate the second information. The generated second information is used to acquire data. That is, the second information is information necessary to acquire data. The second information generated using the first information makes it possible to restrict data acquisition. This means that the first information restricts data acquisition.

Further, the second information also can restrict data acquisition. Since the wireless device 1 can hold the second information after passing through the first gate 21, holding the second information shows that the wireless device 1 is located within the region 22.

The signal strength of data provided by the data providing apparatus 10 through wireless communication attenuates depending on the distance from the source of transmission. Thus, the wireless device 1 can acquire data within a circular area 23 of FIG. 4. Accordingly, the wireless device 1 can actually acquire data only within the area where the region 22 and the circular area 23 overlap each other, which means that the first information and second information restrict the area where data can be acquired.

The first information acquisition part 2 may acquire the first information through proximity wireless communication, for example. More concretely, it is possible to employ a communication method using electromagnetic induction such as NFC (Near Field Communication) and Felica, or a wireless communication method using millimeter wave signals.

The first information acquisition part 2 may acquire the first information using a digital camera, for example. More concretely, the first information may be acquired by a means for converting an image signal into coded data such as QR code (registered trademark).

A part of the first information may be acquired in a location separated from the first gate 21. For example, when a ticket is necessary to pass through the first gate 21, a part of the first information may be acquired when purchasing the ticket.

The first information may be information concerning the date and time when the wireless device 1 passes through the first gate 21, for example. Since the wireless device 1 generates the second information using the first information, the first information concerning date and time makes it possible to generate the second information concerning date and time. Since the data acquisition part 4 acquires data using the second information, the second information concerning date and time makes it possible to change the kind of data to be acquired by the data acquisition part 4, depending on the date and time. For example, when the second information is generated in relation to a certain date, data acquisition may be permitted only on that date.

Instead, the first information may be information concerning the location where the first gate 21 is installed, for example. For example, when the first gate 21 is the entrance of a vehicle such as train, bus, airplane, ship, etc., the first information may be information for identifying the entrance (e.g., the name of the entrance). In this case, the second information relates to the entrance, and the kind of data to be acquired by the data acquisition part 4 can be changed depending on the entrance. For example, when both of a user entered from Entrance A and a user entered from Entrance B move to Entrance C riding on a vehicle, the kind of data to be acquired after entering Entrance C may be changed depending on which one of Entrances A and B is used to ride on the vehicle.

Instead, the first information may be information concerning the purpose of passing through the first gate 21, for example. For example, when the first gate 21 is the entrance of a vehicle such as train, bus, airplane, ship, etc., the first information may relate to the destination of the user riding on the vehicle. Further, for example, when the first gate 21 is the entrance gate of a movie theater, the first information may relate to the title of a movie the user is planning to see. Instead, when the first gate 21 is the entrance gate of a theme park, the first information may relate to the type of ticket of the theme park. In this case, the wireless device 1 can generate the second information in relation to the purpose of the entry, and the data acquisition part 4 can change the kind of data to be acquired, depending on the purpose of the entry. For example, available data can be changed depending on the title the user is planning to see in the movie theater.

The second information generator 3 may be a secure element, for example. For example, the second information may be generated by an application in the secure element to be stored in a memory in the secure element. The secure element incorporated into IC card, SIM card, etc. safely protects the second information so that the second information is not maliciously accessed from the outside and freely read. By providing such a secure element, a high level of security can be realized.

The second information generator 3 may generate the second information not immediately after acquiring the first information, for example. For example, the second information may be generated at the timing of starting the procedure for acquiring data using the second information. For example, when a data acquisition request is inputted by the user holding the wireless device 1, the procedure for acquiring data is started and the second information is generated simultaneously.

The first information acquisition part 2 may acquire the application (program) for generating the second information together with the first information.

The wireless communication area where the data acquisition part 4 acquires data may be broader than the area where the first information acquisition part 2 acquires the first information. Accordingly, the wireless device 1 can acquire the first information only when it is in proximity to or in contact with the first gate 21, and can acquire data anywhere within the area where the region 22 and the circular area 23 overlap each other as shown in FIG. 4, which improves the convenience of the user.

The data acquisition part 4 may use wireless LAN, Bluetooth (registered trademark), cellular communication, WiMAX, etc. Further, when the first information acquisition part 2 uses wireless communication, the first information acquisition part 2 may partially or entirely share the wireless communication with the data acquisition part 4.

As stated above, in the first embodiment, when the user holding the wireless device 1 passes through the first gate 21, the wireless device 1 acquires the first information, and then when the user enters the region 22 inside the first gate 21, the wireless device 1 acquires data from the data providing apparatus 10 by using the second information generated by the wireless device 1 using the first information. This makes it possible to restrict data acquisition, and to prevent data from being freely acquired. That is, the wireless device 1 cannot acquire the first information without passing through the first gate 21, cannot generate the second information without acquiring the first information, and cannot acquire data without the second information. The second information cannot be generated without following the correct procedure, which means that data can be protected by restricting data acquisition.

### Second Embodiment

A second embodiment to be explained below is characterized in restricting data acquisition depending on whether the wireless device 1 exits through a second gate after entering the region 22 through the first gate 21.

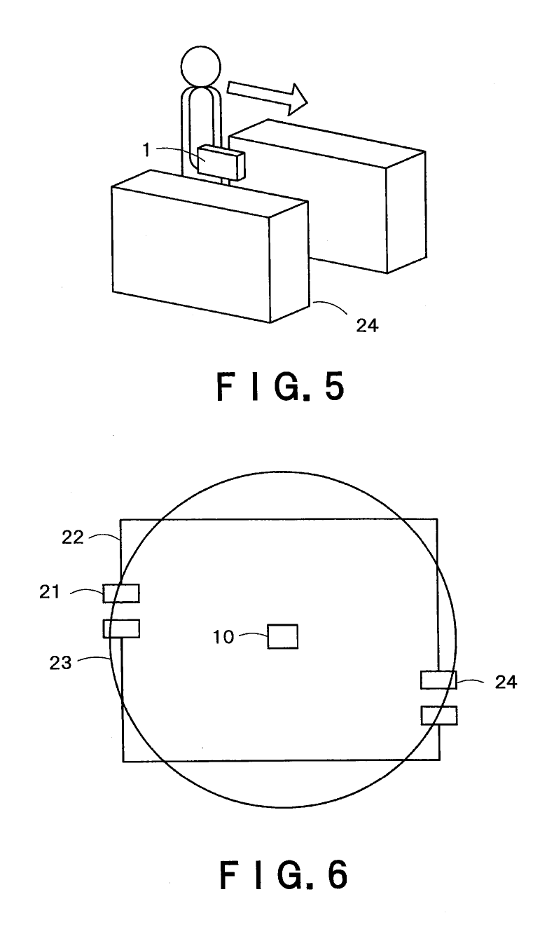

In the present embodiment, not only the first gate 21 for entry but also the second gate for exit is provided. The user holding the wireless device 1 enters the region 22 through the first gate 21, and then exits through a second gate 24 as shown in FIG. 5.

FIG. 6 is a diagram showing the positions of the first and second gates 21 and 24 and the area where data can be acquired. In FIG. 6, the first gate 21 and the second gate 24 are provided at different locations, but the first gate 21 and the second gate 24 may be arranged in proximity to each other, or the first gate 21 and the second gate 24 may be unified into one gate.

In the present embodiment, when the user passes through the second gate 24, the second information generated after the user passes through the first gate 21 is invalidated by the second information generator 3.

By invalidating the second information when the user passes through the second gate 24, it is possible to prohibit acquisition of data as soon as the wireless device 1 is located outside the region 22 of FIG. 6, and it is possible to prevent acquisition of data in the area which is outside the region 22 but within the wireless communication area (the circular area 23 of FIG. 6) of the data providing apparatus 10.

The invalidation of the second information may be achieved by eliminating the second information, for example. In this case, the second information is cleared, and thus when making the second information effective again, the second information must be generated again using the first information. When not only the second information but also the first information is eliminated, the wireless device 1 cannot acquire the first information without passing through the first gate 21 again, which means that data acquisition is permitted only within the period since the wireless device 1 passes through the first gate 21 until the wireless device 1 exits through the second gate 24.

Instead, the invalidation of the second information may be achieved by prohibiting access to the second information continuously retained, for example. In this case, the second information is retained in the wireless device 1, and thus the process for making the second information effective again can be simplified, which means that the second information can be switched between valid and invalid simplify and quickly.

Whether or not to invalidate the second information may be determined based on the first information, for example. For example, when the first information includes information concerning an effective period, the second information may be kept effective even after the wireless device 1 exits through the second gate 24 as long as the time point when the wireless device 1 passes through the second gate 24 is within the effective period of the first information.

Instead, whether or not to invalidate the second information may be determined based on the information which can be acquired by the second gate 24, for example. More concretely, when the information acquired by the second gate 24 shows that the user passes through the second gate 24 to temporarily go outside the region 22 and intends to enter the region 22 again, the invalidation of the second information may be cancelled.

As stated above, in the second embodiment, since the second information is invalidated when the user exits through the second gate 24, data acquisition is prohibited after the exit, which means that data can be protected by preventing the data from being continuously acquired after the exit.

### Third Embodiment

A third embodiment to be explained below is characterized in that the second information is invalidated after the elapse of a predetermined time period since the first information is acquired.

The second information generator 3 in the wireless device 1 according to the third embodiment generates the second information using the first information, and invalidates the second information after the elapse of a predetermined time period since the first information acquisition part 2 acquires the first information.

Even when the wireless device 1 keeps staying within the region 22 as shown in FIGS. 4 and 6, the second information is invalidated after the elapse of a predetermined time period since the first information is acquired, which makes it possible to restrict the period for permitting the wireless device 1 to acquire data. Therefore, it is possible to prevent data from being acquired by the same wireless device 1 for a long period, which leads to protection of data and improvement of security.

A timer (not shown) may be used to judge whether or not a predetermined time period has elapsed. For example, the timer starts measuring time at the time point when the first information acquisition part 2 acquires the first information, and transmits a signal for invalidating the second information to the second information generator 3 at the time point when the time measured by the timer reaches a predetermined time.

Since the timer measures time in association with the operation of the first information acquisition part 2 and the second information generator 3, the second information can be made effective for the correct time period.

Instead, time at the time point when the first information acquisition part 2 acquires the first information may be added to a predetermined time to obtain and manage the calculated time. The second information may be invalidated if the time when the data acquisition part 4 tries to acquire data using the second information is later than the managed time. In this case, timer measurement is not required, which simplifies the process.

As stated above, in the third embodiment, the second information is invalidated after the elapse of a predetermined time period since the first information is acquired. Accordingly, even when the wireless device 1 passes through the first gate 21 and keeps staying in the region 22 for a long period, the wireless device 1 cannot acquire data for a long period.

### Fourth Embodiment

In a fourth embodiment, explanation will be given on the data providing apparatus 10 for providing data to the wireless devices 1 according to the first to third embodiments.

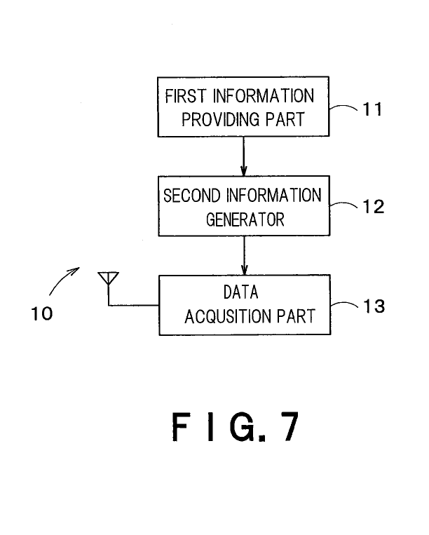

FIG. 7 is a block diagram showing a schematic configuration of the data providing apparatus 10 according to the fourth embodiment.

This data providing apparatus 10 can provide data to the wireless devices 1 according to the first to third embodiments. More concretely, the data providing apparatus 10 may be formed of an entrance gate (the first gate 21) installed at the entrance of a vehicle in the station, airport, harbor, etc., and a wireless communication unit incorporated into this entrance gate. The entrance gate is installed in a facility such as movie theater, amusement park, art museum, science museum, etc.

The data providing apparatus 10 of FIG. 7 has a first information providing part 11, a second information generator 12, and a data providing part 13. The first information providing part 11 provides the first information to the wireless device 1 after passing through the first gate 21. The second information generator 12 generates the second information necessary to provide data, by using the first information provided to the wireless device 1 by the first information providing part 11. The data providing part 13 provides data through wireless communication, by using the second information.

The second information generated by the second information generator 12 in the data providing apparatus 10 is the same as the second information generated by the second information generator 3 in the wireless device 1.

The data providing part 13 provides data through wireless communication within the circular area 23 as shown in FIGS. 4 and 6, without specifying the wireless devices 1 capable of acquiring the data. Since the data is provided using the second information, only the wireless device 1 holding the same second information can acquire this data. As a result, the data providing apparatus 10 can restrict the data provision area.

The data providing part 13 may perform authentication with the wireless device 1 through wireless communication by using the second information in order to provide data using the second information only when the authentication is successful. In this case, the second information functions as an authentication key.

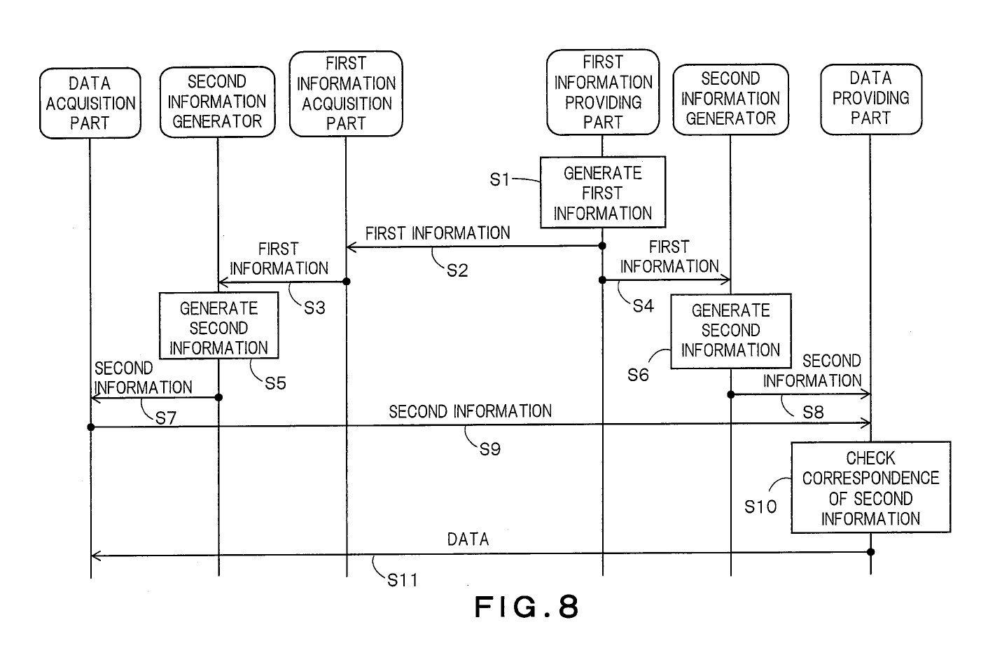

FIG. 8 is a sequence diagram showing an example of processing steps when performing authentication using the second information.

When the user holding the wireless device 1 passes through the first gate 21, the first information providing part 11 generates the first information (Step S1), and provides the generated first information to the wireless device 1. This first information is acquired by the first information acquisition part 2 (Step S2). The first information acquisition part 2 in the wireless device 1 transmits the acquired first information to the second information generator 3 (Step S3). At nearly the same time as Step S3, the first information providing part 11 in the data providing apparatus 10 transmits, to the second information generator 12, the first information provided to the wireless device 1 (Step S4).

The second information generator 3 in the wireless device 1 and the second information generator 12 in the data providing apparatus 10 generate the same second information using their first information (Steps S5 and S6).

The second information generator 3 in the wireless device 1 transmits the generated second information to the data acquisition part 4 (Step S7). At nearly the same time as Step S7, the second information generator 12 in the data providing apparatus 10 transmits the generated second information to the data providing part 13 (Step S8).

Next, the data acquisition part 4 in the wireless device 1 and the data providing part 13 in the data providing apparatus 10 exchange their second information to perform authentication (Step S9). More concretely, it is checked whether the second information of the data acquisition part 4 corresponds to the second information of the data providing part 13 (Step S10). If corresponds, the authentication is judged to be successful, and the data providing apparatus 10 provides data within a predetermined wireless communication area (Step S11). The data can be acquired by the wireless device 1 holding the second information and located within the wireless communication area of the data providing apparatus 10.

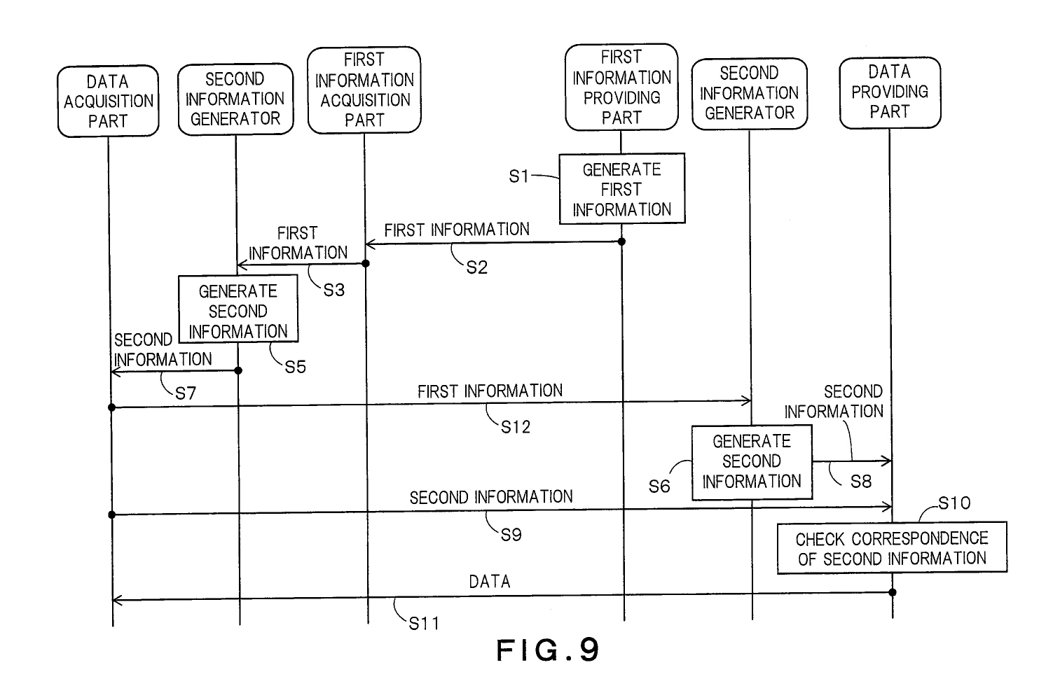

In FIG. 8, the second information generator 12 in the data providing apparatus 10 generates the first information using the second information transmitted from the first information providing part 11. However, the first information may be transmitted to the second information generator 12 not from the first information providing part 11 but from the wireless device 1. FIG. 9 is a sequence diagram showing the processing steps performed in this case. In FIG. 9, the same step numbers are assigned to the same steps as those of FIG. 8, and differences therebetween will be mainly explained.

In FIG. 9, Step S4 of FIG. 8 is omitted. After the second information is generated in the wireless device 1 (Step S8), the data acquisition part 4 transmits the first information to the second information generator 12 in the data providing apparatus 10 (Step S12), and the second information generator 12 generates the second information utilizing the first information (Step S6). Subsequent steps (Step S8 to S11) are similar to those of FIG. 8.

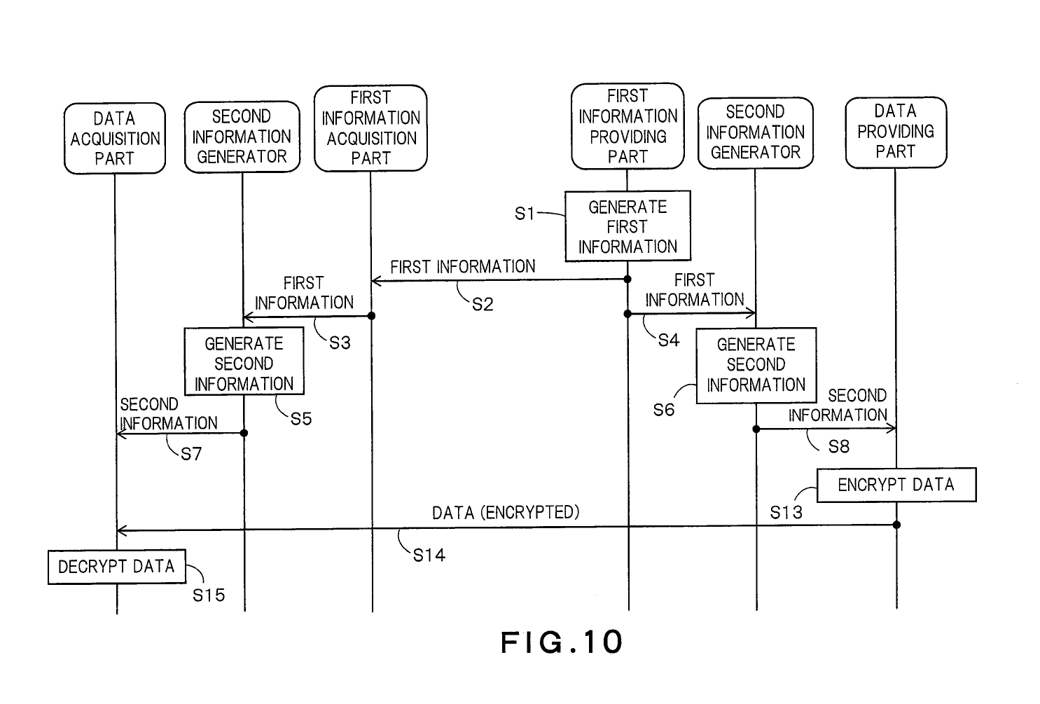

On the other hand, FIG. 10 is a sequence diagram when the second information is not an authentication key but an encryption (decryption) key. In FIG. 10, the same step numbers are assigned to the same steps as those of FIG. 8, and differences therebetween will be mainly explained. Steps S1 to S8 are similar to those of FIG. 8. Since the second information in FIG. 10 is an encryption (decryption) key, the data providing part 13 encrypts data using the second information generated by the second information generator 12 in the data providing apparatus 10 (Step S13), and wirelessly transmits the encrypted data (Step S14).

The wireless device 1 receives the encrypted data, and decrypts it using the second information generated by the second information generator 3 (Step S15).

Regardless of whether the second information is used in the authentication process as shown in FIGS. 8 and 9 or used in the data encryption (decryption) process as shown in FIG. 10, the second information generators 3 and 12 in the wireless device 1 and data providing apparatus 10 perform the same processing steps to generate the second information. The second information generators 3 and 12 generate the same second information by using the same first information.

The first information acquisition part 2 in the data providing apparatus 10 may be incorporated into the first gate 21. Further, the data providing part 13 may be provided within a wireless communication unit provided separately from the first gate 21. The second information generator 12 may be incorporated into any one of the first gate 21 and wireless communication unit, or may be incorporated into a housing separated from the first gate 21 and wireless communication unit.

The second information generator 12 in the data providing apparatus 10 of FIG. 7 may invalidate the second information after the elapse of a predetermined time period since the first information providing part 11 provides the first information to the wireless device 1. In this case, regardless of whether the second information generator 12 in the data providing apparatus 10 acquires the first information from the first information providing part 11 as shown in FIG. 8 or acquires the first information from the wireless device 1 as shown in FIG. 9, the second information may be invalidated after the elapse of a predetermined time period since the first information providing part 11 provides the first information to the wireless device 1.

As stated above, in the fourth embodiment, the second information generator 12 in the data providing apparatus 10 generates the second information using the first information provided to the wireless device 1, to generate the same second information as the second information generated by the second information generator 3 in the wireless device 1. Therefore, the second information generated by the wireless device 1 and the data providing apparatus 10 can be used as an authentication key in the authentication process or can be used as an encryption (decryption) key in the data encryption (decryption) process, which improves security when providing and acquiring data.

### Fifth Embodiment

In the first to fourth embodiments, the data providing apparatus 10 wirelessly transmits data within a predetermined wireless communication area (the circular area as shown in FIGS. 4 and 6) without specifying the wireless devices 1 capable of acquiring data, which means that whether or not to be able to acquire the data depends on each wireless device 1. Therefore, when there are a plurality of wireless devices 1 capable of generating the second information using the first information, the wireless devices 1 can acquire the same data. On the other hand, a fifth embodiment to be explained below is characterized in that the data providing apparatus 10 transmits data so that only specific wireless devices 1 can acquire the data.

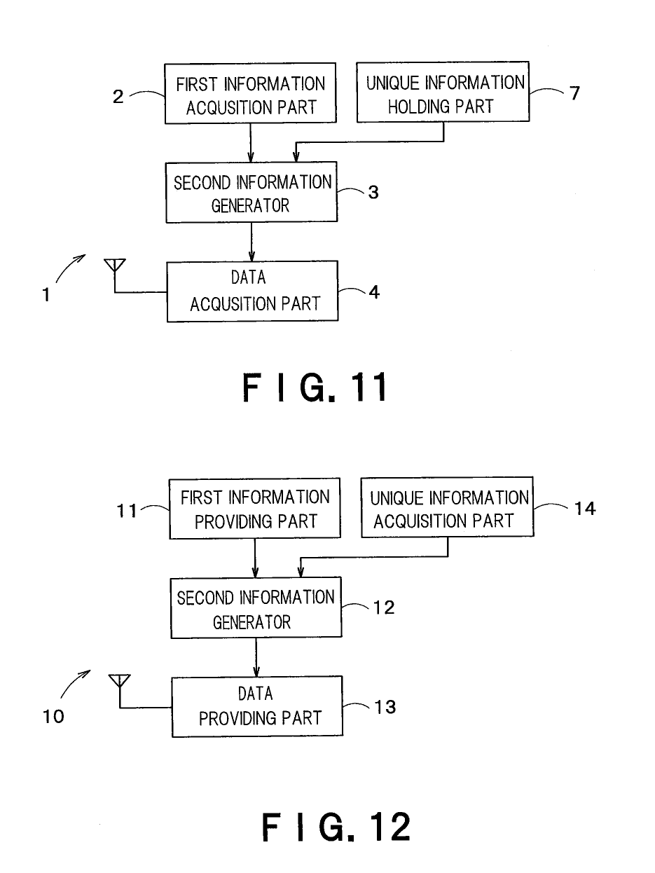

FIG. 11 is a block diagram showing a schematic configuration of the wireless device 1 according to the fifth embodiment. The wireless device 1 of FIG. 11 is obtained by adding a unique information holding part 7 to the wireless device 1 of FIG. 1. The unique information holding part 7 retains a unique ID (hereinafter referred to as unique information) of the wireless device 1. The second information generator 3 in the wireless device 1 of FIG. 11 generates the second information using not only the first information but also the unique information concerning the wireless device 1. Therefore, the second information includes the unique information concerning the wireless device 1, which makes it possible to identify the wireless device 1 by the second information.

FIG. 12 is a block diagram showing a schematic configuration of the data providing apparatus 10 according to the fifth embodiment. The data providing apparatus 10 of FIG. 12 is obtained by adding a unique information acquisition part 14 to the data providing apparatus 10 of FIG. 7. The unique information acquisition part 14 acquires unique information concerning the wireless device 1 by selecting the unique information from one or more pieces of unique information previously registered, or by receiving the unique information transmitted from the wireless device 1.

The second information generator 12 in the data providing apparatus 10 of FIG. 12 generates the second information using not only the first information but also the unique information acquired by the unique information acquisition part 14.

The data providing part 13 in the data providing apparatus 10 transmits data using the second information only when the second information transmitted from the wireless device 1 corresponds to the second information generated by the second information generator 12 in the data providing apparatus 10. Since this data is transmitted using the second information including the unique information concerning the wireless device 1, only the wireless device 1 having the same unique information can acquire this data. Since the number of wireless devices 1 capable of acquiring data can be limited to only one, illegal data acquisition can be prevented more strictly, which leads to improvement of security.

The unique information acquisition part 14 in the data providing apparatus 10 can acquire the unique information concerning the wireless device 1 based on the following two techniques. A first technique is utilizing a database in which unique information concerning one or more wireless devices 1 is previously registered. For example, the user watching a movie in a bullet train is previously required to register the unique information concerning the wireless device 1. In this case, the unique information acquisition part 14 accesses the database and selects an arbitrary piece of unique information. The second information generator 12 generates the second information using the selected unique information and the first information. The data providing part 13 judges whether the generated second information corresponds to the second information transmitted from the wireless device 1. The series of steps are repeated changing a piece of unique information registered in the database until the generated second information corresponds to the second information transmitted from the wireless device 1, and then data is transmitted using the corresponding second information. When the corresponding second information cannot be generated with the unique information registered in the database, transmission of data is cancelled.

In a second technique, the wireless device 1 when passing through the first gate 21 transmits its unique information to the data providing apparatus 10 so that the unique information acquisition part 14 in the data providing apparatus 10 receives and acquires the unique information transmitted from the wireless device 1. Then, the second information generator 12 in the data providing apparatus 10 generates the second information using the acquired unique information and the first information.

According to the second technique, the unique information acquisition part 14 in the data providing apparatus 10 is not required to search a specific piece of unique information from a plurality of pieces of unique information, which reduces the processing load on the data providing apparatus 10. However, it is required to newly provide a transmitter in the wireless device 1 so that the wireless device 1 when passing through the first gate 21 can transmit the unique information to the data providing apparatus 10.

As stated above, in the fifth embodiment, the second information is generated using the unique information concerning the wireless device 1 in addition to the first information so that data transmitted from the data providing apparatus 10 can be acquired only by a specific wireless device 1 having the corresponding unique information. Accordingly, even when a plurality of wireless devices 1 exist close to each other, only the wireless device 1 having the corresponding unique information can acquire data. By limiting the number of wireless devices 1 capable of acquiring data, security can be further improved.

At least a part of the wireless device 1 and data providing apparatus 10 explained in the above embodiments may be formed of hardware or software. In the case of software, a program realizing at least a partial function of the wireless device 1 and data providing apparatus 10 may be stored in a recording medium such as a flexible disc, CD-ROM, etc. to be read and executed by a computer. The recording medium is not limited to a removable medium such as a magnetic disk, optical disk, etc., and may be a fixed-type recording medium such as a hard disk device, memory, etc.

Further, a program realizing at least a partial function of the wireless device 1 and data providing apparatus 10 can be distributed through a communication line (including radio communication) such as the Internet. Furthermore, this program may be encrypted, modulated, and compressed to be distributed through a wired line or a radio link such as the Internet or through a recording medium storing it therein.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A wireless device comprising:
a first information acquisition part configured to acquire first information when the wireless device passes through a first gate;
a second information generator configured to generate second information, by using the first information; and
a data acquisition part configured to acquire data transmitted from another wireless device through wireless communication, by using the second information.

2. The wireless device of claim 1,
wherein after the wireless device passes through a second gate, the second information generator invalidates the second information generated after the wireless device passed through the first gate.

3. The wireless device of claim 1,
wherein the second information generator invalidates the second information after elapse of a predetermined time period since the first information is acquired.

4. The wireless device of claim 1,
wherein the first information is entry information showing that the wireless device passed through the first gate, and
the second information is key information for acquiring the data.

5. The wireless device of claim 4,
wherein the second information is an authentication key, and
the data acquisition part performs authentication with the other wireless device using the authentication key, and acquires, when the authentication is successful, the data from the other wireless device through wireless communication.

6. The wireless device of claim 4,
wherein the second information is a decryption key for decrypting the encrypted data, and
the data acquisition part decrypts the encrypted data with the decryption key.

7. The wireless device of claim 1, further comprising:
a unique information holding part configured to retain unique information concerning the wireless device,
wherein the second information generator generates the second information using the first information and the unique information.

8. The wireless device of claim 7, further comprising:
a unique information transmitter configured to transmit the unique information retained by the unique information holding part to the other wireless device when the wireless device passes through the first gate.

9. The wireless device of claim 1,
wherein an area where the data acquisition part is capable of acquiring the data is broader than an area where the first information acquisition part is capable of acquiring the first information.

10. A wireless device comprising:
a first information providing part configured to provide first information to another wireless device passing through a first gate;
a second information generator configured to generate second information, by using the first information; and
a data providing part configured to provide data through wireless communication, by using the second information.

11. The wireless device of claim 10,
wherein after the wireless device passes through a second gate, the second information generator invalidates the second information generated after the wireless device passed through the first gate.

12. The wireless device of claim 10,
wherein the second information generator invalidates the second information after elapse of a predetermined time period since the first information is provided to the wireless device when passing through the first gate.

13. The wireless device of claim 10,
wherein the first information is entry information showing that the wireless device passed through the first gate, and
the second information is key information for providing the data.

14. The wireless device of claim 13,
wherein the second information is an authentication key, and
the data providing part performs authentication with the wireless device using the authentication key, and provides, when the authentication is successful, the data through wireless communication.

15. The wireless device of claim 13,
wherein the second information is an encryption key for encrypting the data, and
the data providing part encrypts the data with the encryption key.

16. The wireless device of claim 10, further comprising:
a unique information acquisition part configured to acquire unique information concerning the wireless device,
wherein the second information generator generates the second information using the first information and the unique information.

17. A wireless communication method, comprising:
acquiring first information by a wireless device when the wireless device passes through a first gate;
generating second information, by using the first information; and
acquiring data transmitted from another wireless device through wireless communication, by using the second information.

18. The wireless communication method of claim 17,
wherein after the wireless device passes through a second gate, the generating the second information invalidates the second information generated after the wireless device passed through the first gate.

19. The wireless communication method of claim 17,
wherein the generating the second information invalidates the second information after elapse of a predetermined time period since the first information is acquired.

20. The wireless communication method of claim 17,
wherein the first information is entry information showing that the wireless device passed through the first gate, and
the second information is key information for acquiring the data.
